(19) United States
(12) Patent Application Publication
(10) Pub. No.: US 2012/0317205 A1
(43) Pub. Date: Dec. 13, 2012

(54) ANONYMOUS LOCATION-BASED NOTIFICATION

(75) Inventors: Limor Lahiani, Tel Aviv (IL); Yair E. Geva, Zichron Yaakov (IL); Elad Ben-Israel, Tel Aviv (IL)

(73) Assignee: MICROSOFT CORPORATION, Redmond, WA (US)

(21) Appl. No.: 13/157,334

(22) Filed: Jun. 10, 2011

(51) Int. Cl. G06F 15/16

(52) U.S. Cl. 709/206

(57) ABSTRACT

Architecture that enables communication of a message from a requesting (sending) user to a single target user and/or group of target users based on current geographic location of the target user(s) while hiding the identities of the requesting user and the target user(s). This anonymity capability is provided by mediating messages between the users (requesting and target) via an anonymous messaging component (e.g., a service) that maintains anonymity of the users relative to one another. The anonymous messaging component does not publish user identities, since the component mediates between the sender and the receiver(s).

### BACKGROUND

Requesting users and applications may be interested in communicating with target users/applications based on whereabouts of the target user/device without disclosing identities of the parties. For example, a user may want to know if a restaurant is crowded or whether it is worth going to an event. However, there is no way to send a message to “someone located at that location” without exposing the sender's identify or knowing the identity of the target person(s).

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables communication of a message from a requesting (sending) user to a target user or group of target users based on current geographic location of the target user(s) while hiding the identities of the requesting user and the target user(s).

This capability is provided by mediating messages between the users (requesting and target) via an anonymous messaging component (e.g., a service) that maintains anonymity of the users relative to one another. The anonymous messaging component does not publish user identities, since the component mediates between the sender (requester) and the receiver(s) (target(s)).

Given the utilization of location architecture that determines user locations (e.g., a location broker, check-ins, cellular-based location, mobile signals, etc.), the implementation of send and respond message APIs is straightforward. A client application running on the target device (e.g., a mobile phone) receives the message and may act on the message (e.g. display a notification to the target user, perform a predefined action, etc.).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a messaging system in accordance with the disclosed architecture.

FIG. 2 illustrates an alternative system that utilizes anonymous messaging in accordance with the disclosed architecture where the requesting user is outside the site of interest.

FIG. 3 illustrates an alternative system that utilizes anonymous messaging in accordance with the disclosed architecture where the requesting user is inside the site of interest.

FIG. 4 illustrates a system that utilizes anonymous messaging APIs in accordance with the disclosed architecture.

FIG. 5 illustrates a computer-implemented messaging method in accordance with the disclosed architecture.

FIG. 6 illustrates further aspects of the method of FIG. 5.

FIG. 7 illustrates an alternative messaging method.

FIG. 8 illustrates further aspects of the method of FIG. 7.

FIG. 9 illustrates a block diagram of a computing system that executes anonymous messaging in accordance with the disclosed architecture.

### DETAILED DESCRIPTION

The disclosed architecture enables communication of a message from a requesting (sending) user to a single target user and/or group of target users based on current geographic location of the target user(s) while hiding the identities of the requesting user and the target user(s). This can be useful to determine information about a site of interest, such as a restaurant, outdoor site, scenic overlook, temporary site (e.g., police checkpoint), traffic conditions, weather conditions, product information, as well as from within the site of interest such as for anonymous user-to-user communications at a site. For example, in a discotheque, people in the discotheque can anonymously engage other users for social interaction.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

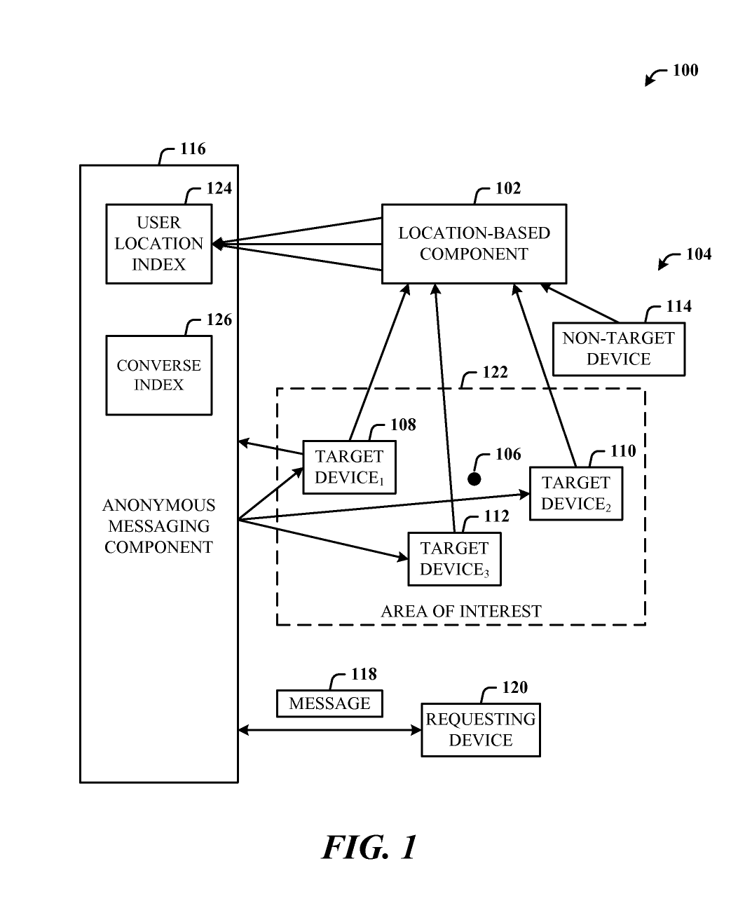

FIG. 1 illustrates a messaging system 100 in accordance with the disclosed architecture. The system 100 includes a location-based component 102 (e.g., global positioning system (GPS) that determines the geographic location of user devices 104 (e.g., mobile devices, vehicle systems, etc.) relative to a site of interest 106 (e.g., a business, residence, park, hiking trail, etc.). The user devices 104 include target devices (e.g., a first target device 108, a second target device 110, and a third target device 112) and a non-target device 114, for example.

The system 100 also employs an anonymous messaging component 116 (e.g., a network-based service) that receives a message 118 from a requesting device 120, where the message 118 is related to the site of interest 106. The anonymous messaging component 116 directs the message 118 to the target devices (108, 110, and 112) of the user devices 104 in an area of interest 122 (associated with the site of interest 106) and hides the identity of the requesting device 120 from the target devices (108, 110, and 112).

The anonymous messaging component 116 also hides the identity of target devices (108, 110, and/or 112) that reply to the message 118. The anonymous messaging component 116 receives the message 118 based on geographical coordinates of the site of interest 106 and a predefined distance around the site of interest 106. The anonymous messaging component 116 assigns a token to the message 118 to identify the message 118 with the requesting device 120.

The anonymous messaging component 116 comprises a user location index 124 that maps a geographic polygon (e.g., a geographic tile) to a target device(s) (e.g., any one or more of the target devices 108, 110, and/or 112). The anonymous messaging component 116 also comprises a conversation index 126 (denoted converse index) that maintains messages sent to target devices (e.g., any one or more of the target devices 108, 110, and/or 112). The anonymous messaging component 116 can employ a push-notification technology to push the message 118 to the target devices (108, 110, and 112) and push a response to the requesting device 120.

The geographical area of interest 122 is depicted as a polygon that can be rectangle or square section about the site of interest 106. In this example, as a geographical tile, the area of interest 122 can be a rectangle or a square. When processing maps (cartography), the maps can be processed (downloaded) as tiles. As employed in this example embodiment, the area of interest 122 in which the site of interest 106 is located can comprise a single tile or multiple tiles. In another embodiment, the areas are not processed/indexed as tiles, but can be indexed differently. All that is needed is the ability to identify the tile(s) (e.g., by latitude, longitude, and size such as perimeter or radius) and then to map the tile(s) and location information to the site of interest 106 and the target devices (108, 110 and 112). Note that in an alternative embodiment, the area of interest 122 can be circular and defined according to a radius value and the latitude-longitude coordinates of the location of the site of interest 106.

In general, the system 100 can include a client application (that executes on the user device, e.g., a mobile phone), the location brokerage system (the location-based component 102) that identifies the geolocation of users (via user devices) at any given time, and the anonymous location-based messaging service (anonymous messaging component 116) that provides the anonymous message communications between users (based on user whereabouts). The location-based component 116 enables users to share the associated current user location with other users in a secure and controlled manner.

The application can be a text messaging application. However, the architecture can be generalized to many types of applications that are not text messaging applications. The client application sends and receives messages. When a user wants to send a message, the user opens the client application and utilizes a map or local search to find a location (the site of interest 106) on the map. The user then enters a text message and enables communication (e.g., send) of the message 118. The client application contacts the anonymous messaging component 116, which sends the message 118 along with parameters such as geographical coordinates (e.g., latitude, longitude), and radius of the map target (the site of interest 106) selected by the user. The messaging protocol can employ a “send-message-to-all-users-in-tile” API (application program interface). The messaging component 116 replies with the token, which is used to identify the specific message.

With respect to receiving messages, any push-notification service can be employed to receive text messages at a target device. Once the message is received at a target user (e.g., of a target device 108) and the target user opens the application associated with the push-notification, the client application enables the target user to send a response back to the requesting user (of the requesting device 120). The response is then sent to the requesting device 120 via the messaging component 116 using a “send-response-to-message” API. The token, which is received inside the push-notification, is used by the messaging component 116 to correlate the message to the sender (the user of the requesting device 120).

The anonymous messaging component 116 uses the location-based component 102 to create the user location index 124 of users and associated current location. The location-based component 102 updates the anonymous messaging component 116 whenever a user device 104 (target or not-target) publishes new location information (e.g., lat-long or check-in based). When the update arrives at the anonymous messaging component 116, the anonymous messaging component 116 updates the user location index 124 accordingly.

The user location index 124 is maintained by the messaging component 116. The index user location index 124 maps an area of interest to a target user (e.g., a geo-tile to a target user). The world can be divided into areas of equal size and each area identifiable by area identifiers. For example, a geo-tile is a representation of an area anywhere in the world. Tiles are useful because the tiles can be represented as a hierarchal search tree. Thus, it is relatively easy to find all the users in a certain location for a certain resolution (e.g., simply select the depth in the tree based on the resolution desired in the search).

The messaging component 116 also maintains a list of all the conversations (one or more messages) that take place in the conversations index 126. When a requesting user creates a conversation (e.g., uses the “send-message-to-all-users-in-tile” API), a new entry is allocated in that list, keyed by a conversation (message) token previously described. This entry includes the identity of the sender (user and/or requesting device) and optionally, other control information as desired.

The anonymous component 116 provides at least two APIs. The send message API (e.g., send-message-to-all-users-in-tile (tiles-of-interest, message): conversationToken), looks up all the users (users of target devices) for all given tiles based on the geo-index and sends a push-notification to all of the target devices with the message and the message token. The send response API (e.g., send-response-to-message (conversationToken, message): void) looks up the conversation in the conversation index 126 and sends a push-notification to the originator (requesting device 120) of the conversation (e.g., the message sent and message response).

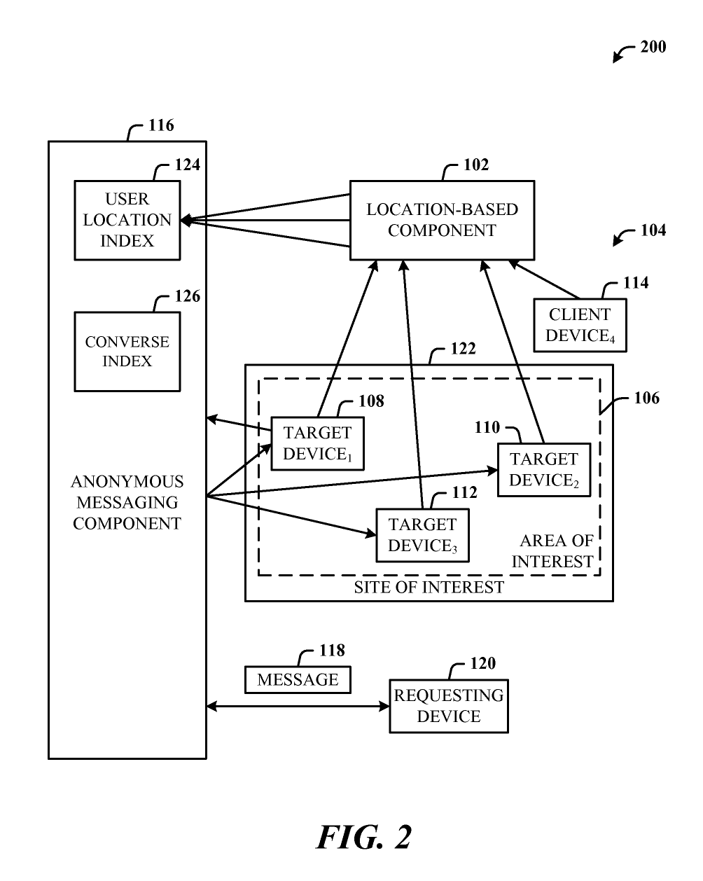

FIG. 2 illustrates an alternative system 200 that utilizes anonymous messaging in accordance with the disclosed architecture where the requesting user is outside the site of interest 122. The system 200 includes the entities and components of the system 100 of FIG. 1; however, in this scenario, the anonymous messaging occurs between the requesting device 120 (requesting user) outside the site of interest 122 to target users (of devices 108, 110 and 112) inside the area of interest 106, which is inside the site of interest 122. In other words, it is now possible to communicate anonymously to attendees in a different part of a ballpark, for example, a convention hall, a restaurant, etc., from outside the venue (e.g., parking lot). In a restaurant setting, the requesting user can now inquire about the quality of the food and service for the particular evening, and the waiting time, for example.

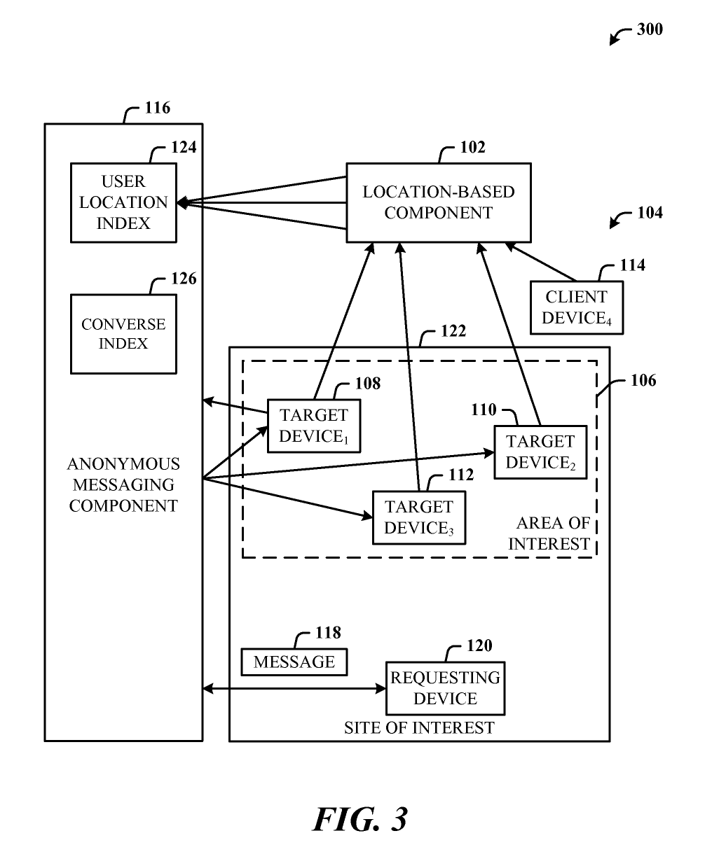

FIG. 3 illustrates an alternative system 300 that utilizes anonymous messaging in accordance with the disclosed architecture where the requesting user is inside the site of interest 122. The system 300 includes the entities and components of the system 100 of FIG. 1; however, in this scenario, the anonymous messaging occurs between the requesting device 120 (requesting user) inside the site of interest 122 (yet outside the area of interest 106) to target users (of devices 108, 110 and 112) inside the area of interest 106. In other words, it is now possible to communicate anonymously to attendees in a different part of restaurant, discotheque, a convention hall, etc., from another point inside the site of interest 122. In the discotheque, the disclosed architecture can facilitate dating and/or social interaction anonymously before disclosing user identity, for example.

The disclosed anonymous messaging architecture can be managed by a user security model that enables the user (e.g., target) to opt-in or opt-out so that perceived personal information is not published, such as for the geolocation information determined by the location-based component 102. Accordingly, a security component (not shown) can be employed for authorized and secure handling of user and/or device information. The security component enables the user to opt-in and opt-out of allowing location information as well as personal information that may have been obtained from being utilized thereafter. The user can be provided with notice of the collection of personal information, for example, and the opportunity to provide or deny consent to do so, at either or both of the remote user device 108 or/and the stationary computing device 104.

Consent can take several forms. Opt-in consent imposes on the user to take an affirmative action before the data is collected and processed. Alternatively, opt-out consent imposes on the user to take an affirmative action to prevent the collection of data before that data is collected. This is similar to implied consent in that by doing nothing, the user allows the data collection after having been adequately informed.

A dialog box can be presented as to notice and consent. The dialog box asks for consent via a radio button, for example to opt-in to the data collection, includes an explanation on what the data will be used for, and can also include a prominent link to a privacy policy statement. The security component ensures the proper collection, storage, and access to the user information while allowing for the dynamic selection and presentation of the content, features, and/or services.

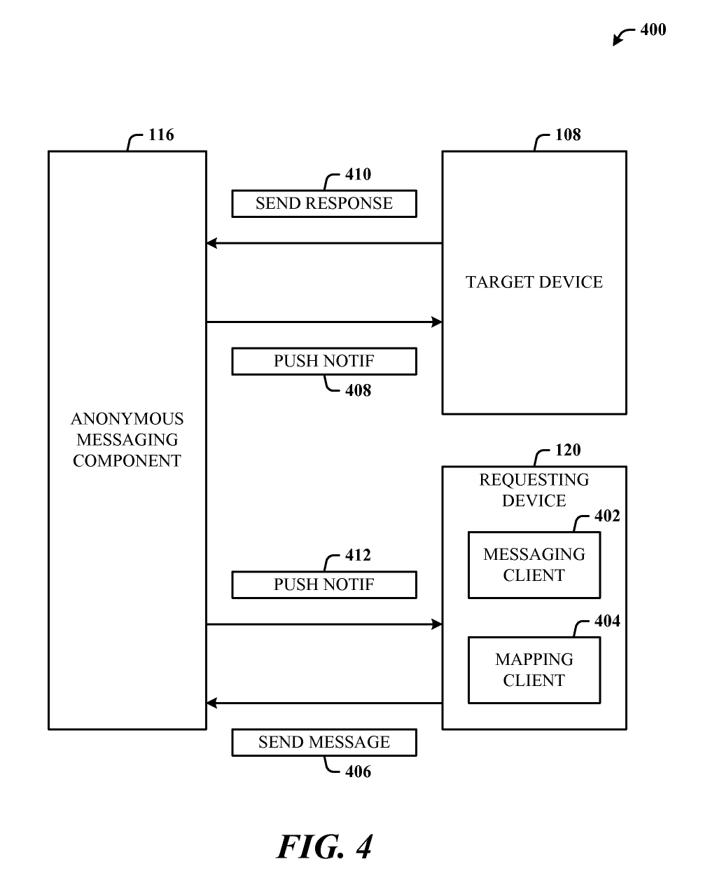

FIG. 4 illustrates a system 400 that utilizes anonymous messaging APIs in accordance with the disclosed architecture. When a user of the requesting device 120 wants to send a message (the message 118), the user opens a messaging client 402 and utilizes a mapping or local search client 404 to find a location on a map of the site of interest 106. The user then enters a text message into the messaging client 402 and sends the message 118. The message 118 is sent in a send message API 406;

send-message-to-all-users-in-SOI (site-of-interest, message):
conversationToken

where SOI is the site of interest. If tiles are employed, the API can be the following,

send-message-to-all-users-in-tiles (tiles-of-interest, message):
conversationToken

If the message is “is it crowded”, to inquire about the possibility of getting into the venue (the site of interest 122), the send API can be the following:

send-message-to-all-users-in-SOI (site-of-interest, “is it crowded”):
conversationToken

The messaging client 402 contacts the anonymous messaging component 116, which sends the message 118 along with parameters such as geographical coordinates (e.g., latitude, longitude), and radius of the map target (the site of interest 106) selected by the user.

The messaging component 116 pushes the message 118 anonymously to the target device 108 (and other possible target devices) using a push notification (denoted Push Notif) API 408.

Once the message 118 is received at the user target device 108 and the target user opens the application associated with the push-notification, the client application enables the target user to send a response back to the requesting user (of the requesting device 120) via the messaging component 116 using a send-response API 410.

The send response API 410 can be the following:

send-response-to-message (conversationToken, message): void)

looks up the conversation in the conversation index 126 and sends a push-notification to the originator (the requesting device 120) of the conversation (e.g., the message sent and message response). Thus, where the response is “no, come over”, the response API look like,

send-response-to-message (conversationToken, : “no, come over”):
void)

The token, which is received inside the push-notification, is used by the messaging component 116 to correlate the message to the sender (the user of the requesting device 120). The messaging component 116 pushes the response anonymously to the requesting device 120 using the push-notification API 412 (which can be similar to the push-notification API 408).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

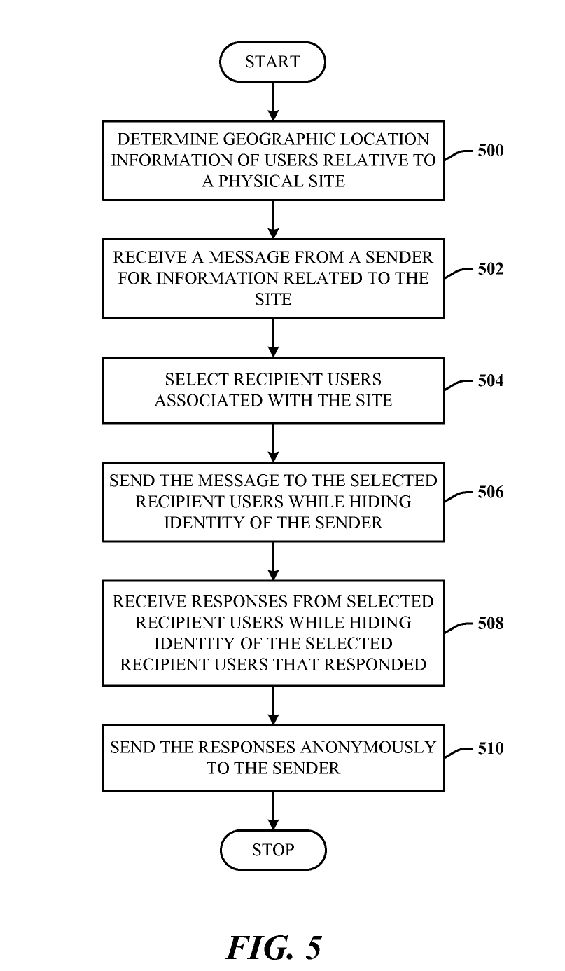

FIG. 5 illustrates a computer-implemented messaging method in accordance with the disclosed architecture. At 500, geographic location information of users (e.g., target and non-target) relative to a physical site is determined. At 502, a message is received from a sender for information related to the site. At 504, recipient users associated with the site are selected (within scope of an area of interest). Alternatively, the selection can be based on user profile (known attributes and preferences). Thus, where many users, the system can select users with similar profiles to the requesting user. For example, when requesting if “the bar is playing good music”, it is desirable ask people with similar music tastes, rather than anybody in the bar. At 506, the message is sent to the selected recipient users while hiding the identity of the sender (the message is sent anonymously). At 508, responses are received from selected recipient users. At 510, the responses are sent to the sender while hiding the identity of the selected recipient users that responded (the responses are sent anonymously).

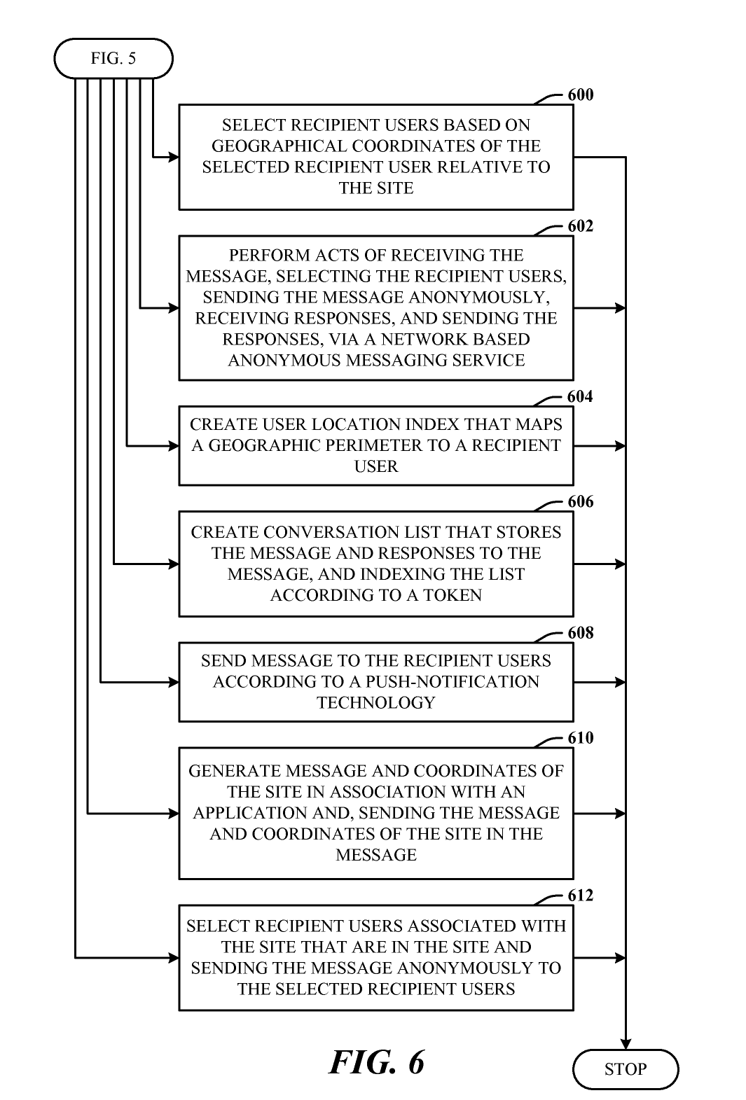

FIG. 6 illustrates further aspects of the method of FIG. 5. Note that the flow indicates that each block can represent a step that can be included, separately or in combination with other blocks, as additional aspects of the method represented by the flow chart of FIG. 5. At 600, the recipient users are selected based on geographical coordinates of the selected recipient user relative to the site. At 602, the acts of receiving the message, selecting the recipient users, sending the message anonymously, receiving responses, and sending the responses, are performed via a network-based anonymous messaging service. At 604, a user location index is created that maps a geographic perimeter to a recipient user. At 606, a conversation list is created that stores the message and responses to the message, and indexing the list according to a token. At 608, the message is sent to the recipient users according to a push-notification technology. At 610, the message and coordinates of the site are generated in association with an application and, the message and coordinates of the site are sent in the message. At 612, the recipient users associated with the site that are in the site are selected and the message is sent anonymously to the selected recipient users.

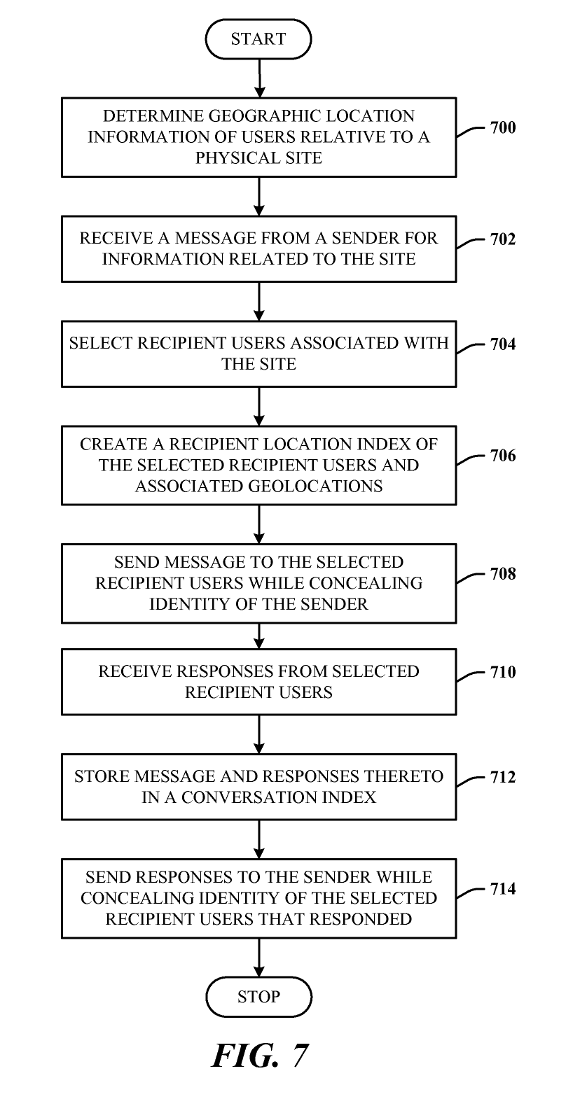

FIG. 7 illustrates an alternative messaging method. At 700, geographic location information of users relative to a physical site is determined. At 702, a message is received from a sender for information related to the site. At 704, recipient users associated with the site are selected. At 706, a recipient location index of the selected recipient users and associated geolocations is created. At 708, the message is sent to the selected recipient users while concealing identity of the sender. At 710, responses are received from selected recipient users. At 712, the message and responses thereto are stored in a conversation index. At 714, the responses are sent to the sender while concealing identity of the selected recipient users that responded.

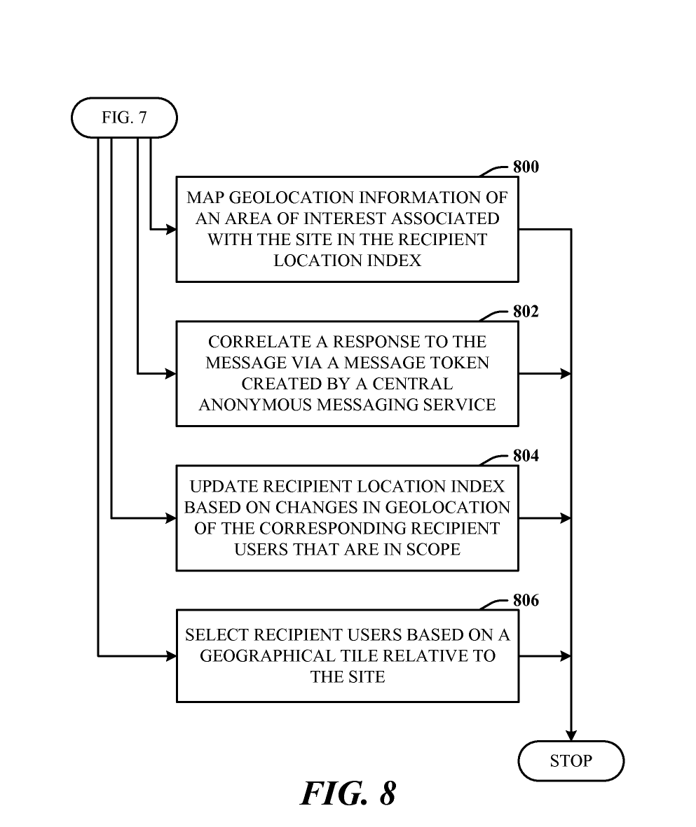

FIG. 8 illustrates further aspects of the method of FIG. 7. Note that the flow indicates that each block can represent a step that can be included, separately or in combination with other blocks, as additional aspects of the method represented by the flow chart of FIG. 7. At 800, geolocation information of an area of interest associated with the site is mapped in the recipient location index. At 802, a response to the message is correlated via a message token created by a central anonymous messaging service. At 804, the recipient location index is updated based on changes in geolocation of the corresponding recipient users that are in scope. At 806, the recipient users are selected based on a geographical tile relative to the site.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

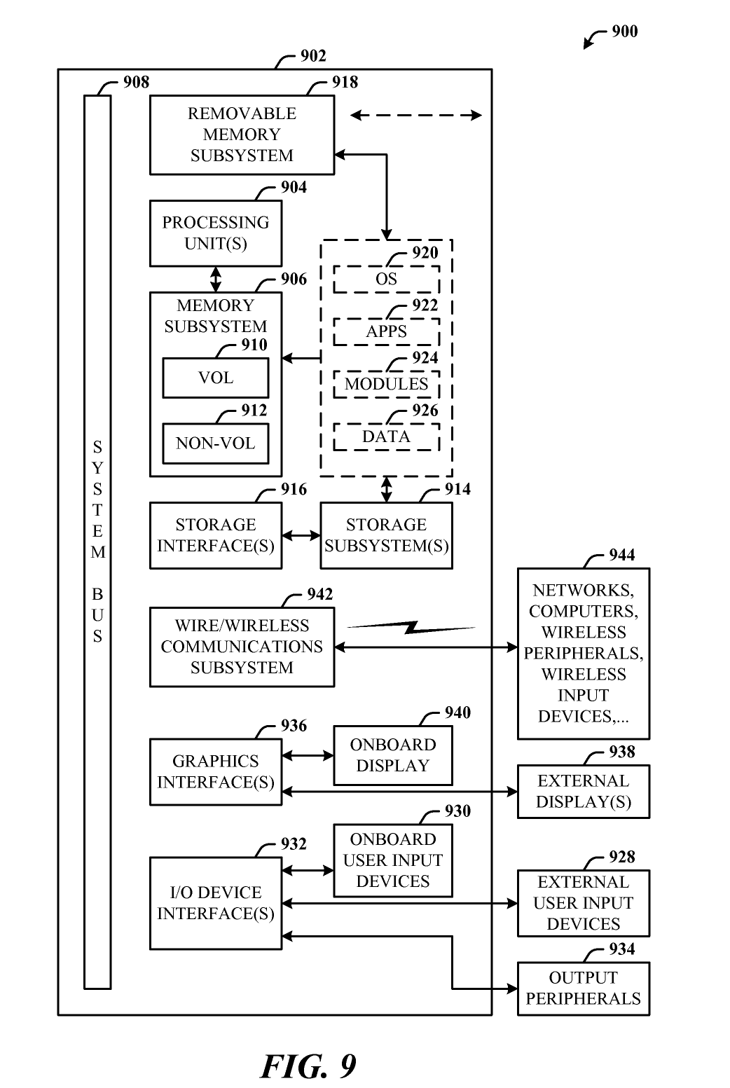

Referring now to FIG. 9, there is illustrated a block diagram of a computing system 900 that executes anonymous messaging in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a computer-readable storage such as a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include computer-readable storage (physical storage media) such as a volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components. The storage subsystem(s) 914 (physical storage media) can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include entities and components of the system 100 of FIG. 1, entities and components of the system 200 of FIG. 2, entities and flow of the system 300 of FIG. 3, entities and components of the system 400 of FIG. 4, and the methods represented by the flowcharts of FIGS. 5-8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 902 and includes volatile and non-volatile internal and/or external media that is removable or non-removable. For the computer 902, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

It is to be understood that the illustrated aspects are also suitable for use in mobile devices such as cell phones, mobile-capable devices such as tablet PCs, and the like.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented messaging system, comprising:
a location-based component that determines geographic location of user devices relative to a site of interest;
an anonymous messaging component that receives a message from a requesting device, the message related to the site of interest, and the anonymous messaging component directs the message to target devices of the user devices in an area of interest related to the site of interest and hides identity of the requesting device from the target devices; and
a processor that executes computer-executable instructions associated with at least the anonymous messaging component.

2. The system of claim 1, wherein the anonymous messaging component hides identity of target devices that reply to the message.

3. The system of claim 1, wherein the anonymous messaging component receives the message based on geographical coordinates of the site of interest and a predefined value that defines a perimeter relative to the site of interest.

4. The system of claim 1, wherein the anonymous messaging component assigns a token to the message to identify the message with the requesting device.

5. The system of claim 1, wherein the anonymous messaging component comprises a user location index that maps a geographic polygon to a target device.

6. The system of claim 1, wherein the anonymous messaging component comprises a conversation index that maintains messages sent to target devices.

7. The system of claim 1, wherein the anonymous messaging component employs a push-notification technology to push the message to the target devices and a response to the requesting device.

8. A computer-implemented messaging method, comprising acts of:
determining the geographic location information of users relative to a physical site;
receiving a message from a sender for information related to the site;
selecting recipient users associated with the site;
sending the message to the selected recipient users while hiding identity of the sender;
receiving responses from selected recipient users;
sending the responses to the sender while hiding identity of the selected recipient users that responded; and
utilizing a processor that executes instructions stored in memory to perform at least one of the acts of determining, receiving, or selecting.

9. The method of claim 8, further comprising selecting the recipient users based on geographical coordinates of the selected recipient user relative to the site.

10. The method of claim 8, further comprising performing the acts of receiving the message, selecting the recipient users, sending the message anonymously, receiving responses, and sending the responses, via a network-based anonymous messaging service.

11. The method of claim 8, further comprising creating a user location index that maps a geographic perimeter to a recipient user.

12. The method of claim 8, further comprising creating a conversation list that stores the message and responses to the message, and indexing the list according to a token.

13. The method of claim 8, further comprising sending the message to the recipient users according to a push-notification technology.

14. The method of claim 8, further comprising generating the message and coordinates of the site in association with an application and, sending the message and coordinates of the site in the message.

15. The method of claim 8, further comprising selecting the recipient users associated with the site that are in the site and sending the message anonymously to the selected recipient users.

16. A computer-implemented messaging method, comprising acts of:
determining geographic location information of users relative to a physical site;
receiving a message from a sender for information related to the site;
selecting recipient users associated with the site;
creating a recipient location index of the selected recipient users and associated geolocations;
sending the message to the selected recipient users while concealing identity of the sender;
receiving responses from selected recipient users;
storing the message and responses thereto in a conversation index;
sending the responses to the sender while concealing identity of the selected recipient users that responded; and
utilizing a processor that executes instructions stored in memory to perform at least one of the acts of receiving, creating, storing, or selecting.

17. The method of claim 16, further comprising mapping geolocation information of an area of interest associated with the site in the recipient location index.

18. The method of claim 16, further comprising correlating a response to the message via a message token created by a central anonymous messaging service.

19. The method of claim 16, further comprising updating the recipient location index based on changes in geolocation of the corresponding recipient users that are in scope.

20. The method of claim 16, further comprising selecting the recipient users based on a geographical tile relative to the site.
